(19) United States
(12) Patent Application Publication
(10) Pub. No.: US 2025/0024031 A1
(43) Pub. Date: Jan. 16, 2025

(54) ADAPTIVE FILTER FOR DECODER-SIDE INTRA MODE DERIVATION

(71) Applicant: Tencent America LLC, Palo Alto, CA (US)

(72) Inventors: Biao WANG, San Jose, CA (US); Roman CHERNYAK, Santa Clara, CA (US); Xin ZHAO, San Jose, CA (US); Madhu PERINGASSERY KRISHNAN, Mountain View, CA (US); Lien-Fei CHEN, Hsinchu (TW); Shan LIU, San Jose, CA (US)

(73) Assignee: Tencent America LLC, Palo Alto, CA (US)

(21) Appl. No.: 18/768,879

(22) Filed: Jul. 10, 2024

Related U.S. Application Data
(60) Provisional application No. 63/525,855, filed on Jul. 10, 2023.

(51) Int. Cl. H04N 19/117; H04N 19/105; H04N 19/176; H04N 19/70

(52) U.S. Cl. CPC H04N 19/117; H04N 19/105; H04N 19/176; H04N 19/70

(57) ABSTRACT

Aspects of the disclosure includes methods and apparatuses for video decoding and video encoding and a method of processing visual media data. The apparatus for video decoding includes processing circuitry that receives coded information indicating that a current block in a current picture is coded with a decoder-side intra mode derivation (DIMD) mode. A template of the current block includes reconstructed samples in the current picture and is adjacent to the current block. The template includes one of a left template and a top template. The processing circuitry determines a filter type from a plurality of filter types associated with the one of the left template and the top template, applies the DIMD mode to the template based on the determined filter type to determine one or more intra prediction modes for the current block, and reconstructs the current block according to the one or more intra prediction modes.

### RELATED APPLICATION

The present application claims the benefit of priority to U.S. Provisional Application No. 63/525,855, “Decoder side intra mode derivation” filed on Jul. 10, 2023, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

### SUMMARY

Aspects of the disclosure include methods and apparatuses for video encoding/decoding.

In an aspect, a method of processing visual media data includes processing a bitstream of the visual media data according to a format rule. The bitstream includes a first syntax element indicating that a current block in a current picture is coded with a decoder-side intra mode derivation (DIMD) mode. A template of the current block that includes reconstructed samples in the current picture is adjacent to the current block and includes one of a left template to the left of the current block and a top template above the current block. The format rule specifies that a filter type is determined from a plurality of filter types associated with the one of the left template and the top template, the DIMD mode is applied to the reconstructed samples in the template based on the determined filter type to determine one or more intra prediction modes for the current block, and the current block is reconstructed according to the one or more intra prediction modes.

In an example, the one of the left template and the top template is the left template, the plurality of filter types includes a 3×3 Sobel filter and a 3×2 Sobel-based filter, the 3×2 Sobel-based filter includes a horizontal filter Mix and a vertical filter M_{ty}, a middle row in Mₗₓ is [0, 0], a sum of each column in Mₗₓ is 0, and a sum of each row in M_{ty} is 0. The bitstream includes a second syntax element indicating which one of the 3×3 Sobel filter and the 3×2 Sobel-based filter is applied to the left template. The format rule specifies that the filter type is determined as one of the 3×3 Sobel filter and the 3×2 Sobel-based filter based on the second syntax element.

In an example, the one of the left template and the top template is the top template, the plurality of filter types includes a 3×3 Sobel filter and a 2×3 Sobel-based filter, the 2×3 Sobel-based filter includes a horizontal filter Mₜₓ and a vertical filter M_{ty}, a middle column in M_{ty} is

$$[ \begin{matrix}0 \\ 0\end{matrix} ] ,$$

a sum of each row in M_{ty} is 0, and a sum of each column in Mₜₓ is 0. The bitstream includes a third syntax element indicating which one of the 3×3 Sobel filter and the 2×3 Sobel-based filter is applied to the top template. The format rule specifies that the filter type is determined as one of the 3×3 Sobel filter and the 2×3 Sobel-based filter based on the third syntax element.

In an example, the one of the left template and the top template is the left template and includes multiple columns of reconstructed samples. The filter type is a 3×2 Sobel-based filter in the plurality of filter types. The 3×2 Sobel-based filter includes a horizontal filter Mₗₓ that is

$$[ \begin{matrix}- 1 & - 3 \\ 0 & 0 \\ 1 & 3\end{matrix} ]$$

and a vertical filter M_{ty} that is

$$[ \begin{matrix}1 & - 1 \\ 2 & - 2 \\ 1 & - 1\end{matrix} ] .$$

The format rule specifies that, for each group of reconstructed samples in a 3×2 sliding window that traverses the left template one row at a time across the multiple columns of samples, Mₗₓ and M_{ty} are applied to the respective group of reconstructed samples in the 3×2 sliding window to determine an intra prediction mode associated with the respective group of reconstructed samples in the sliding window and the one or more intra prediction modes of the current block are determined based on the determined intra prediction modes associated with the respective groups of reconstructed samples in the left template.

In an example, the one of the left template and the top template is the top template and includes multiple rows of reconstructed samples. The filter type is a 2×3 Sobel-based filter in the plurality of filter types. The 2×3 Sobel-based filter includes that a horizontal filter Mₜₓ that is

$$[ \begin{matrix}- 1 & - 2 & - 1 \\ 1 & 2 & 1\end{matrix} ]$$

and a horizontal filter M_{ty} that is

$$[ \begin{matrix}1 & 0 & - 1 \\ 3 & 0 & - 3\end{matrix} ] .$$

The format rule specifies that, for each group of reconstructed samples in a 2×3 sliding window that traverses the top template one column at a time across the multiple rows of samples, Mₜₓ and M_{ty} are applied to the respective group of reconstructed samples in the 2×3 sliding window to determine an intra prediction mode associated with the respective group of reconstructed samples in the sliding window and the one or more intra prediction modes of the current block are determined based on the determined intra prediction modes associated with the respective groups of reconstructed samples in the top template.

In an aspect, a method for video encoding includes determining a filter type from a plurality of filter types associated with one of a left template to the left of a current block and a top template above the current block. The current block in a current picture is coded with a decoder-side intra mode derivation (DIMD) mode. A template of the current block that includes samples in the current picture is adjacent to the current block and includes the one of the left template and the top template. The method for video encoding includes applying the DIMD mode to the samples in the template based on the determined filter type to determine one or more intra prediction modes for the current block, encoding the current block according to the one or more intra prediction modes, and encoding, in a bitstream, a syntax element indicating the filter type for the one of the left template and the top template.

In an example, when the one of the left template and the top template is the left template, the plurality of filter types include a 3×3 Sobel filter and a 3×2 Sobel-based filter, the 3×2 Sobel-based filter indicates a horizontal filter Mₗₓ and a vertical filter M_{ly}, a middle row in Mₗₓ is [0, 0], a sum of each column in Mₗₓ is 0, and a sum of each row in M_{ly} is 0, and the syntax element for the left template indicates one of the 3×3 Sobel filter and the 3×2 Sobel-based filter for the left template.

In an example, when the one of the left template and the top template is the top template, the plurality of filter types include a 3×3 Sobel filter and a 2×3 Sobel-based filter, the 2×3 Sobel-based filter indicates a horizontal filter Mₜₓ and a vertical filter M_{ty}, a middle column in M_{ty} is

$$[ \begin{matrix}0 \\ 0\end{matrix} ] ,$$

a sum of each row in M_{ty} is 0, and a sum of each column in Mₜₓ is 0, and the syntax element for the top template indicates one of the 3×3 Sobel filter and the 2×3 Sobel-based filter for the top template.

In an example, the template includes the top template and the left template, the top template includes the samples that are directly above the current block and the samples that are above and to the right of the current block, the left template includes the samples that are directly to the left of the current block and the samples that are below and to the left of the current block.

In an example, the template includes four adjacent lines of the samples. The applying the DIMD mode includes for each of two middle lines of the four adjacent lines of the samples, applying a filter type to each group of samples in a sliding window to determine an intra prediction mode associated with the group of samples in the sliding window that traverses the middle line one sample at a time and determining the one or more intra prediction modes from the intra prediction modes associated with the respective groups of the samples in the template.

In an example, the one of the left template and the top template is the left template and includes multiple columns of samples. The filter type is a 3×2 Sobel-based filter in the plurality of filter types. The 3×2 Sobel-based filter includes a horizontal filter Mₗₓ that is

$$[ \begin{matrix}- 1 & - 3 \\ 0 & 0 \\ 1 & 3\end{matrix} ]$$

and a vertical filter M_{ly} that is

$$[ \begin{matrix}1 & - 1 \\ 2 & - 2 \\ 1 & - 1\end{matrix} ] .$$

The applying the DIMD mode includes, for each group of samples in a 3×2 sliding window that traverses the left template one row at a time across the multiple columns of samples, applying Mₗₓ and M_{ly} to the respective group of samples in the 3×2 sliding window to determine an intra prediction mode associated with the respective group of samples in the sliding window and determine the one or more intra prediction modes of the current block based on the determined intra prediction modes associated with the respective groups of samples in the left template.

In an example, the one of the left template and the top template is the top template and includes multiple rows of samples. The filter type is a 2×3 Sobel-based filter in the plurality of filter types. The 2×3 Sobel-based filter includes that a horizontal filter Mₜₓ that is

$$[ \begin{matrix}- 1 & - 2 & - 1 \\ 1 & 2 & 1\end{matrix} ]$$

and a horizontal filter M_{ty} that is

$$[ \begin{matrix}1 & 0 & - 1 \\ 3 & 0 & - 3\end{matrix} ] .$$

The applying the DIMD mode includes, for each group of samples in a 2×3 sliding window that traverses the top template one column at a time across the multiple rows of samples, applying Mₜₓ and M_{ty} to the respective group of samples in the 2×3 sliding window to determine an intra prediction mode associated with the respective group of samples in the sliding window and determine the one or more intra prediction modes of the current block based on the determined intra prediction modes associated with the respective groups of samples in the top template.

According to an aspect of the disclosure, an apparatus for video decoding includes processing circuitry. The processing circuitry is configured to receive coded information indicating that a current block in a current picture is coded with a decoder-side intra mode derivation (DIMD) mode. T template of the current block that includes reconstructed samples in the current picture is adjacent to the current block and includes one of a left template to the left of the current block and a top template above the current block. The processing circuitry is configured to determine a filter type from a plurality of filter types associated with the one of the left template and the top template, apply the DIMD mode to the reconstructed samples in the template based on the determined filter type to determine one or more intra prediction modes for the current block, and reconstruct the current block according to the one or more intra prediction modes.

In an aspect, the one of the left template and the top template is the left template. The plurality of filter types includes a 3×3 Sobel filter and a 3×2 Sobel-based filter, the 3×2 Sobel-based filter includes a horizontal filter Mₗₓ and a vertical filter M_{ly}, a middle row in Mₗₓ is [0, 0], a sum of each column in Mₗₓ is 0, and a sum of each row in M_{ly} is 0. A syntax element in the coded information indicates which one of the 3×3 Sobel filter and the 3×2 Sobel-based filter is applied to the left template. The filter type is determined as one of the 3×3 Sobel filter and the 3×2 Sobel-based filter based on the syntax element.

In an aspect, the one of the left template and the top template is the top template. The plurality of filter types includes a 3×3 Sobel filter and a 2×3 Sobel-based filter, the 2×3 Sobel-based filter includes a horizontal filter Mₜₓ and a vertical filter M_{ty}, a middle column in M_{ty} is

$$[ \begin{matrix}0 \\ 0\end{matrix} ] ,$$

a sum of each row in M_{ty} is 0, and a sum of each column in Mₜₓ is 0. A syntax element in the coded information indicates which one of the 3×3 Sobel filter and the 2×3 Sobel-based filter is applied to the top template. The filter type is determined as one of the 3×3 Sobel filter and the 2×3 Sobel-based filter based on the syntax element.

In an example, the one of the left template and the top template is the left template and includes multiple columns of reconstructed samples. The filter type is a 3×2 Sobel-based filter in the plurality of filter types. The 3×2 Sobel-based filter includes a horizontal filter Mₗₓ that is

$$[ \begin{matrix}- 1 & - 3 \\ 0 & 0 \\ 1 & 3\end{matrix} ]$$

and a vertical filter M_{ly} that is

$$[ \begin{matrix}1 & - 1 \\ 2 & - 2 \\ 1 & - 1\end{matrix} ] .$$

For each group of reconstructed samples in a 3×2 sliding window that traverses the left template one row at a time across the multiple columns of samples, the processing circuitry is configured to apply Mₗₓ and M_{ly} to the respective group of reconstructed samples in the 3×2 sliding window to determine an intra prediction mode associated with the respective group of reconstructed samples in the sliding window. The processing circuitry is configured to determine the one or more intra prediction modes of the current block based on the determined intra prediction modes associated with the respective groups of reconstructed samples in the left template.

In an example, the multiple columns of reconstructed samples are four columns.

In an example, the one of the left template and the top template is the top template and includes multiple rows of reconstructed samples. The filter type is a 2×3 Sobel-based filter in the plurality of filter types. The 2×3 Sobel-based filter includes that a horizontal filter Mₜₓ that is

$$[ \begin{matrix}- 1 & - 2 & - 1 \\ 1 & 2 & 1\end{matrix} ]$$

and a horizontal filter M_{ty} that is

$$[ \begin{matrix}1 & 0 & - 1 \\ 3 & 0 & - 3\end{matrix} ]$$

For each group of reconstructed samples in a 2×3 sliding window that traverses the top template one column at a time across the multiple rows of samples, the processing circuitry is configured to apply Mₜₓ and M_{ty} to the respective group of reconstructed samples in the 2×3 sliding window to determine an intra prediction mode associated with the respective group of reconstructed samples in the sliding window. The processing circuitry is configured to determine the one or more intra prediction modes of the current block based on the determined intra prediction modes associated with the respective groups of reconstructed samples in the top template.

In an example, the multiple rows of samples are four rows.

In an example, the template includes the top template and the left template, the top template includes the reconstructed samples that are directly above the current block and the reconstructed samples that are above and to the right of the current block, the left template includes the reconstructed samples that are directly to the left of the current block and the reconstructed samples that are below and to the left of the current block.

In an example, the processing circuitry is configured to determine the filter type based on one of (i) locations of the respective samples in the template relative to the current block, (ii) a block size of the current block, (iii) a block shape of the current block, (iv) a location of the current block in one of the current picture and a current coding tree unit (CTU), and (v) reference lines.

In an example, the template includes multiple lines of the reconstructed samples. For each group of reconstructed samples in a sliding window that traverses a middle line one sample at a time across the multiple lines, the processing circuitry is configured to apply a filter type to the respective group of reconstructed samples in the sliding window to determine an intra prediction mode associated with the respective group of reconstructed samples in the sliding window. The processing circuitry is configured to determine the one or more intra prediction modes of the current block based on the determined intra prediction modes associated with the respective groups of reconstructed samples in the template. The sliding window traverses the middle line except one or more of the rightmost sample of the middle line and the bottommost sample of the middle line.

In an example, the template includes four adjacent lines of the reconstructed samples. For each of two middle lines of the four adjacent lines of the reconstructed samples, the processing circuitry is configured to apply a filter type to each group of reconstructed samples in a sliding window to determine an intra prediction mode associated with the group of reconstructed samples in the sliding window that traverses the middle line one sample at a time. The processing circuitry is configured to determine the one or more intra prediction modes of the current block from the determined intra prediction modes associated with the respective groups of reconstructed samples in the template.

Aspects of the disclosure also provide an apparatus for video encoding. The apparatus for video encoding includes processing circuitry configured to implement any of the described methods for video encoding.

Aspects of the disclosure also provide a method for video decoding. The method includes any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4A shows an example of intra mode coding with 67 intra prediction modes according to an aspect of the disclosure.

FIG. 4B shows intra prediction modes according to an aspect of the disclosure.

FIG. 5 shows an example of 4 reference lines 0-3 adjacent to a current block according to an aspect of the disclosure.

FIG. 6 shows an example of an intra template matching prediction (IntraTMP) mode according to an aspect of the disclosure.

FIG. 7 shows an example of using reconstructed samples in a template (711) to derive one or more intra prediction modes used to predict a current block (701) according to an aspect of the disclosure.

FIG. 8 shows an example of using reconstructed samples in a template (811) to derive one or more intra prediction modes used to predict a current block (701) according to an aspect of the disclosure.

FIG. 9 shows an example of extending a template (711) of a current block (701) to generate a template (911) according to an aspect of the disclosure.

FIG. 10 shows an example of using multiple lines of reconstructed samples as center positions of a filter(s) according to an aspect of the disclosure.

FIG. 11 shows a flow chart outlining a decoding process according to some aspects of the disclosure.

FIG. 12 shows a flow chart outlining an encoding process according to some aspects of the disclosure.

FIG. 13 is a schematic illustration of a computer system in accordance with an aspect.

### DETAILED DESCRIPTION

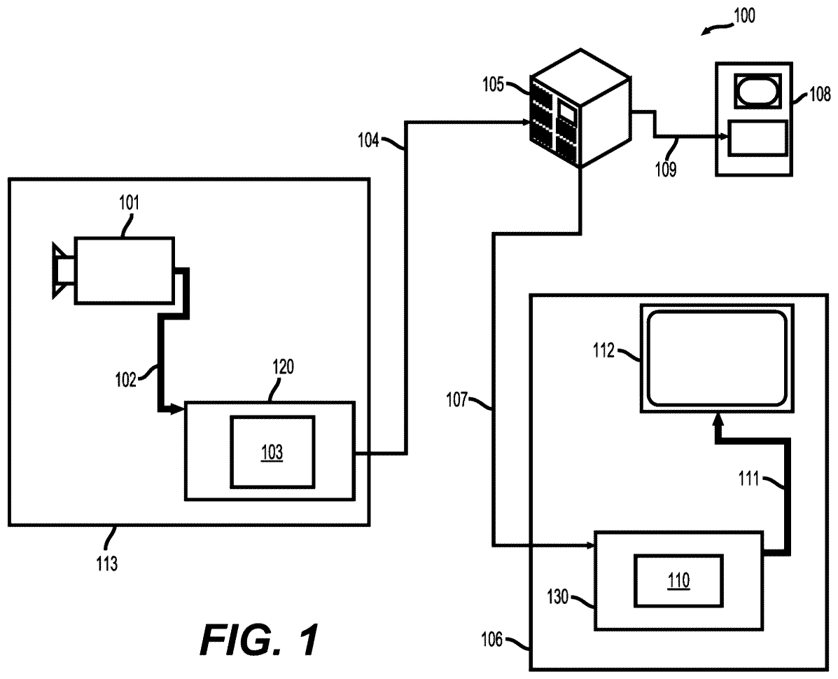

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other video enabled applications, including, for example, video conferencing, digital TV, streaming services, storing of compressed video on digital media including CD, DVD, memory stick and the like, and so on.

The video processing system (100) includes a capture subsystem (113), that may include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

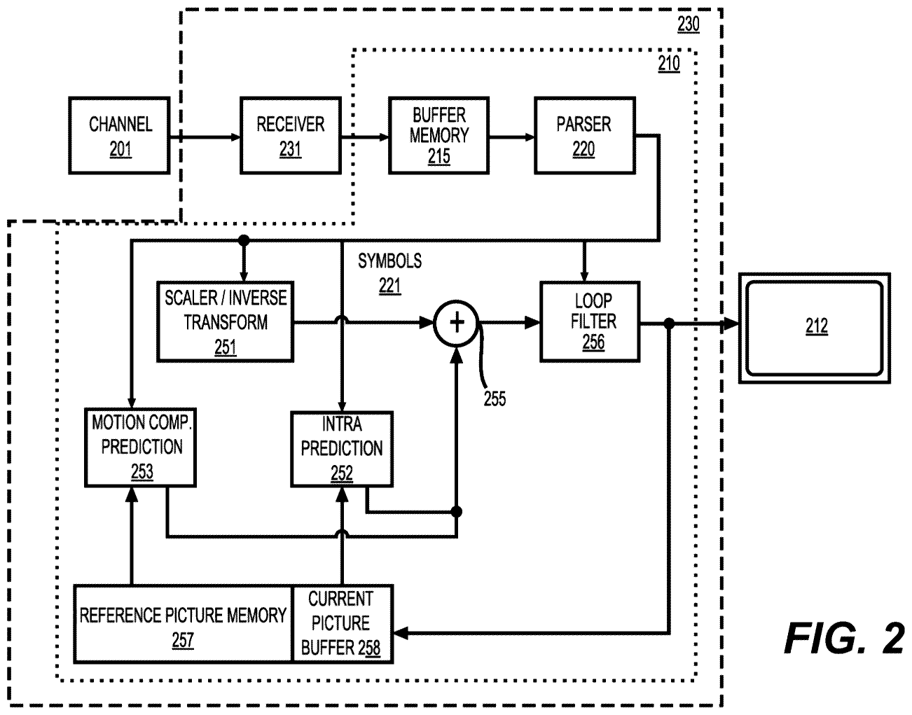

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

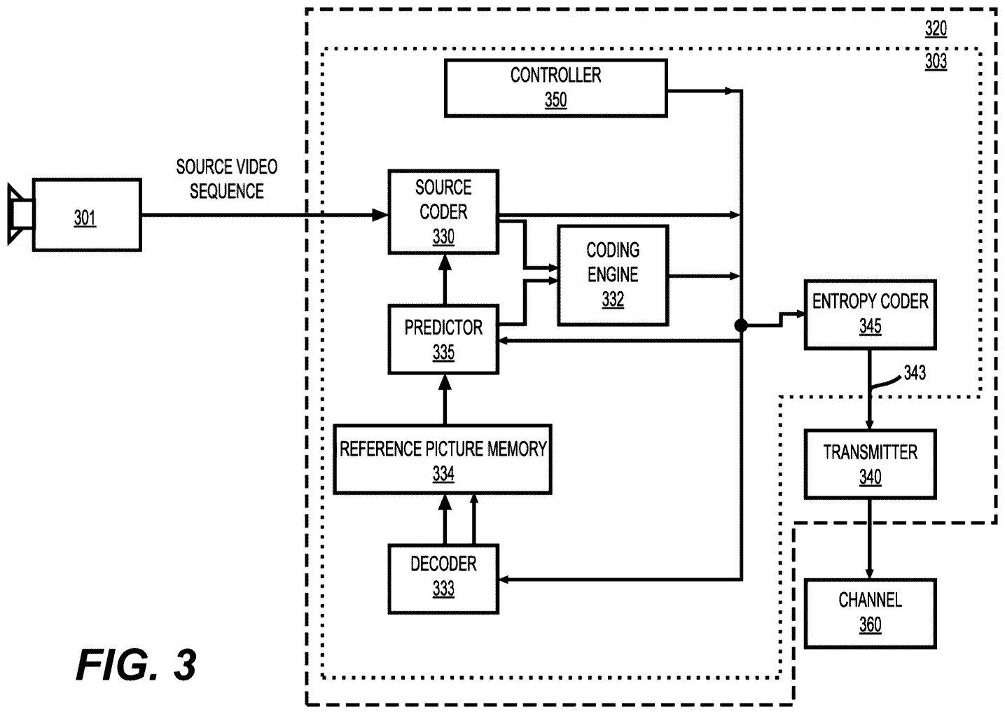

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Intra prediction may be used in video and/or image coding. Intra prediction techniques may include the DC and planar modes, angular prediction modes, matrix-based prediction modes for a luma component, cross-component prediction modes for a chroma component, and the like. Additional intra coding tools such as used in VVC as compared to HEVC may include: 67 intra mode with wide angles mode extension; block size and mode dependent 4 tap interpolation filter; position dependent intra prediction combination (PDPC); cross component linear model (CCLM) intra prediction; multi-reference line (MRL) intra prediction; intra sub-partitions (ISP); weighted intra prediction with matrix multiplication; and the like.

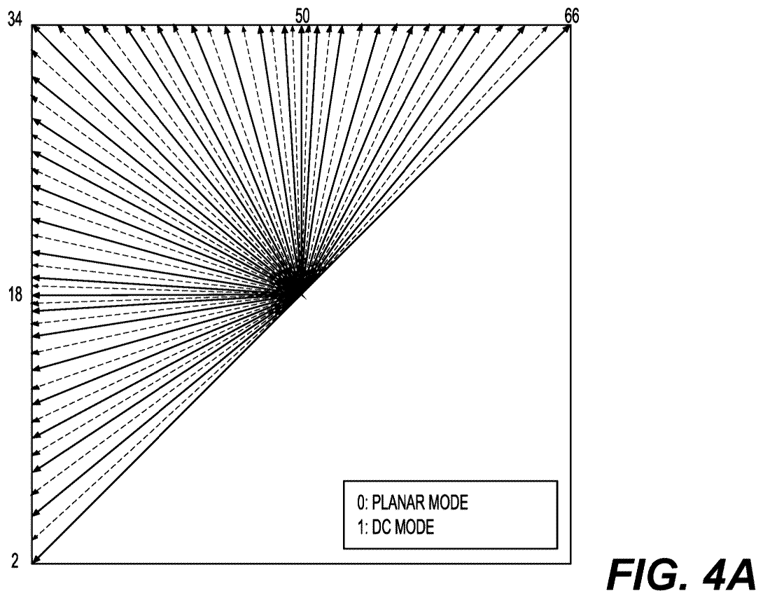

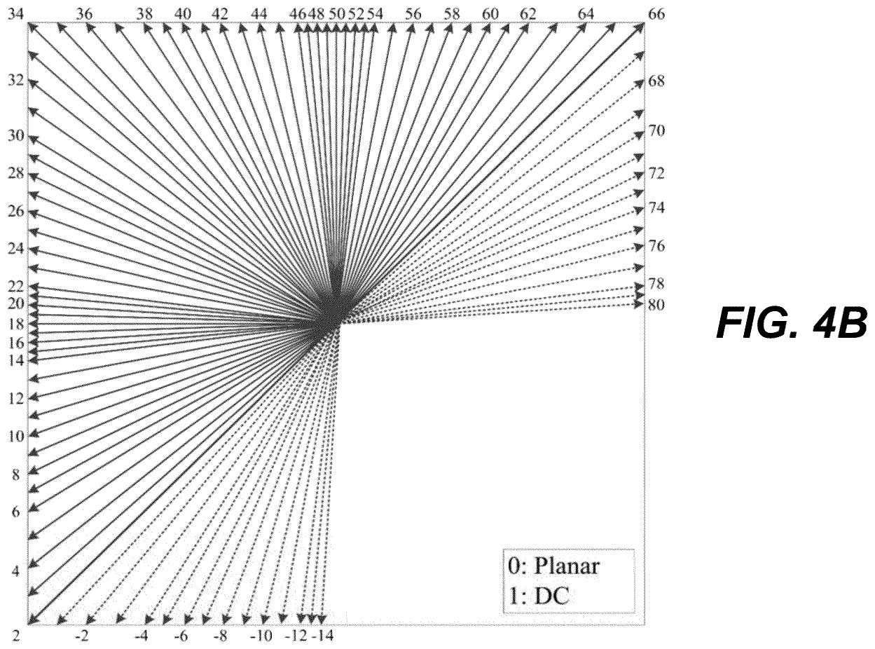

In an example, intra mode coding with 67 intra prediction modes is illustrated in FIG. 4A. To capture the arbitrary edge directions presented in a natural video, the number of directional intra modes (also referred to as angular intra prediction modes) such as used in VVC is extended from 33 as used in HEVC to 65. The new directional modes that are not in HEVC are depicted as dotted arrows in FIG. 4A, and the planar and DC modes remain the same. The denser directional intra prediction modes may apply to various block sizes (e.g., all block sizes) and to both luma and chroma intra predictions. In an example, such as in VVC, certain angular intra prediction modes are adaptively replaced with wide-angle intra prediction modes for the non-square blocks.

In an example, such as in HEVC, an intra-coded block (e.g., every intra-coded block) has a square shape and the length of each side may be a power of 2. Thus, no division operations are required to generate an intra-predictor using the DC mode. In an example, such as in VVC, blocks can have a rectangular shape. In some examples, a division operation per block may be used (e.g., may be required). To avoid division operations for the DC prediction, in some examples, only the longer side is used to compute the average for non-square blocks.

An example of intra mode coding is described as follows. To keep the complexity of the most probable mode (MPM) list generation low, an intra mode coding method with 6 MPMs may be used by considering two available neighboring intra modes. The following three aspects may be considered to construct the MPM list: default intra modes, neighboring intra modes, and derived intra modes. In an example, a unified 6-MPM list is used for intra blocks irrespective of whether MRL and ISP coding tools are applied or not. The MPM list may be constructed based on intra modes of the left and above neighboring blocks of the current block.

In an example, a 4-tap interpolation filter and reference sample smoothing may be applied. Four-tap intra interpolation filters (IF) may be utilized to improve the directional intra prediction accuracy. A two-tap linear interpolation filter, such as in HEVC, may be used to generate the intra prediction block in the directional prediction modes (e.g., excluding Planar and DC predictors). In some examples, such as in VVC, two sets of 4-tap IFs may replace lower precision linear interpolation such as in HEVC, where one set is a DCT-based interpolation filter (DCTIF) and the other set is a 4-tap smoothing interpolation filter (SIF). The DCTIF may be constructed in the same way as the one used for chroma component motion compensation in both HEVC and VVC. The SIF may be obtained by convolving the 2-tap linear interpolation filter with a [1 2 1]/4 filter.

Depending on the intra prediction mode, the following reference samples processing may be performed in some examples:
The directional intra-prediction mode is classified into one of the following groups:
   Group A: vertical or horizontal modes (HOR_IDX, VER_IDX),
   Group B: directional modes that represent non-fractional angles (−14, −12, −10, −6, 2, 34, 66, 72, 76, 78, 80,) and Planar mode,
   Group C: remaining directional modes;
If the directional intra-prediction mode is classified as belonging to the group A, then no filters are applied to reference samples to generate predicted samples;
Otherwise, if a mode falls into the group B and the mode is a directional mode, and all of the following conditions are true, then a [1, 2, 1] reference sample filter may be applied (depending on the mode dependent intra smoothing (MDIS) condition) to reference samples to further copy the filtered values into an intra predictor according to the selected direction, but no interpolation filters are applied:
   refIdx is equal to 0 (no MRL)
   TU size is greater than 32
   Luma
   No ISP block
Otherwise, if a mode is classified as belonging to the group C, an MRL index is equal to 0, and the current block is not an ISP block, then only an intra reference sample interpolation filter is applied to reference samples to generate a predicted sample that falls into a fractional or integer position between reference samples according to a selected direction (no reference sample filtering is performed). The interpolation filter type is determined as follows:
   Set minDistVerHor equal to Min (Abs (predModeIntra-50), Abs (predModeIntra-18))
   Set nTbS equal to (Log2 (W)+Log2 (H))>>1
   Set intraHorVerDistThres [nTbS] as specified below:

| | nTbS = 2 | nTbS = 3 | nTbS = 4 | nTbS = 5 | nTbS = 6 | nTbS = 7 |
|---|---|---|---|---|---|---|
| intraHorVerDistThres | 24 | 14 | 2 | 0 | 0 | 0 |
| [nTbS] | | | | | | |

If minDistVerHor is greater than intraHorVerDistThres [nTbS], SIF is used for the interpolation
Otherwise, DCTIF is used for the interpolation.

FIG. 4B shows intra prediction modes, such as intra prediction modes defined in VVC, according to an aspect of the disclosure. Referring to FIG. 4B, there are 95 intra prediction modes (e.g., a total of 95 intra prediction modes). In an example, the 95 intra prediction modes are indicated by modes −14 to 80. For example, the mode 18 is a horizontal mode, the mode 50 is a vertical mode, and the mode 2, the mode 34, and the mode 66 are diagonal modes. Modes −14 to −1 and 2 to 80 can be referred to as angular intra prediction modes. In an example, the modes −14 to −1 and 67 to 80 can be referred to as Wide-Angle Intra Prediction (WAIP) modes.

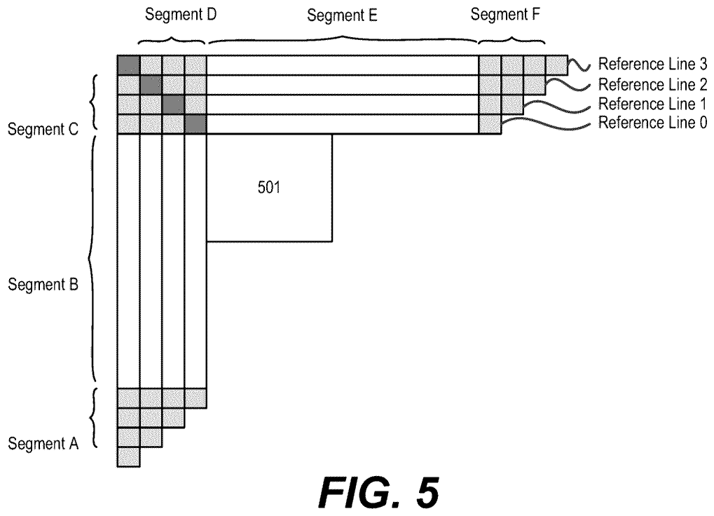

Multi-line intra prediction can be applied to video coding. In multi-line intra prediction, more reference lines (e.g., more than a reference line that is adjacent to a current block to be coded) can be used for intra prediction. An encoder can decide and signal which reference line is used to generate an intra predictor. A reference line index can be signaled before intra prediction modes. In an example, only the most probable modes are allowed in case a nonzero reference line index is signaled. FIG. 5 shows an example of 4 reference lines 0-3 adjacent to a current block (501) according to an aspect of the disclosure. In an aspect, each reference line includes six segments, i.e., Segments A to F, together with a top-left reference sample. In an example, Segments A and F are padded with the closest samples from Segments B and E, respectively.

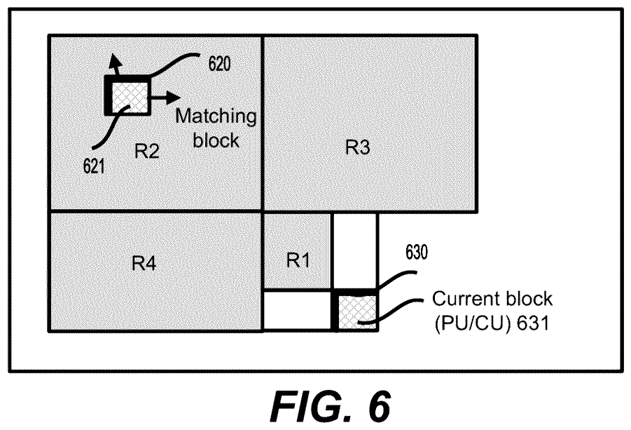

FIG. 6 shows an example of the IntraTMP mode according to an aspect of the disclosure. In an example, the IntraTMP mode is a special intra prediction mode. In an example, the IntraTMP mode is different from the intra prediction mode. Referring to FIG. 6, in an example of the IntraTMP mode, a prediction block (621) such as the best prediction block from a reconstructed part of a current frame may be copied. A template (620) such as an L-shaped template of the prediction block (621) may match a current template (630) of a current block (631). For a predefined search range, the encoder may search for the most similar template to the current template (630) in the reconstructed part of the current frame and may use the corresponding block (621) as a prediction block. In an example, the encoder then signals the usage of the IntraTMP mode, and the same prediction operation is performed at the decoder side.

Referring to FIG. 6, the prediction signal may be generated by matching the L-shaped causal neighbor of the current block (631) with another block in a predefined search area. In an example, the predefined search area includes or consists of: R1 that is a current CTU, R2 that is a top-left CTU of the current CTU, R3 that is an above CTU of the current CTU, and R4 that is a left CTU of the current CTU. In an example, a sum of absolute differences (SAD) is used as a cost function.

Within each region, the decoder may search for a template that has a least cost (e.g., a least SAD) with respect to the current template and may use a block corresponding to the least cost as a prediction block.

The dimensions of all regions (SearchRange_w, SearchRange_h) may be set to be proportional to a block dimension (BlkW, BlkH) to have a fixed number of SAD comparisons per pixel. In an example, SearchRange_w=a×BlkW, and SearchRange_h=a×BlkH, where ‘a’ is a constant that controls a trade-off between gain and complexity. In an example, ‘a’ is equal to 5.

To speed-up the template matching process, in some examples, the search range of all search regions is subsampled, for example, by a factor of 2, and thus leading to a reduction of template matching search by 4. After finding the best match, a refinement process may be performed. The refinement process may be performed via a second template matching search around the best match with a reduced range. In an example, the reduced range is defined as min (BlkW, BlkH)/2.

The Intra template matching tool may be enabled for CUs with a size less than or equal to 64 in width and height. The maximum CU size for the IntraTMP mode may be configurable.

Intra prediction explores spatial redundancy between a current block and neighboring samples of the current block. For example, to code a block using intra prediction, multiple intra prediction modes may be defined, and a selection of one of the multiple intra prediction modes may be predicted and further signaled. Different intra prediction modes may generate prediction sample values using different predefined models. The different predefined models may include (1) averaging neighboring samples, (2) interpolating the prediction samples using neighboring samples with a given prediction direction, such as in an angular intra prediction mode, and the like to predict a sample in the current block. In some examples, due to the correlation of spatial textures in image and/or video content, intra prediction modes selected for adjacent blocks may be highly correlated. Accordingly, intra prediction mode(s) of the current block may not need to be signaled. Instead, the intra prediction mode(s) of the current block may be derived by analyzing a template of the current block.

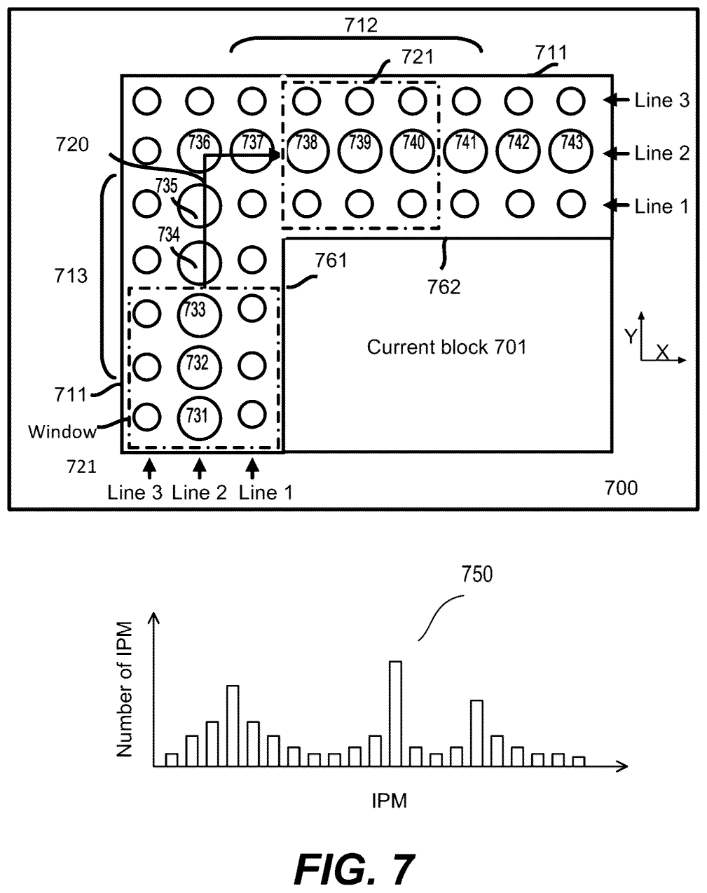

A decoder-side intra mode derivation (DIMD) mode may be applied to derive the intra prediction mode(s) of the current block. FIG. 7 shows an example of using reconstructed samples (also referred to as reconstructed neighboring samples) in a template (711) to derive one or more intra prediction modes used to predict a current block (701) in a current picture (700), for example, by using the DIMD mode. When the DIMD is applied, one or more intra prediction modes such as N intra prediction modes may be derived from the template (711). In an example, the current block (701) may be predicted based on the N intra prediction modes.

In an example, filter(s) (e.g., a 3×3 Sobel filter) may be applied to different areas in the template (711). Positions of the areas may be indicated by a window (721) at different positions, e.g., the window (721) traverses or slides across the template (711). Thus, the window (721) may be referred to as a sliding window. For a group of reconstructed samples in each area or in the window (721) at each position, a horizontal gradient Gx and a vertical gradient Gy may be obtained by applying, for example, horizontal and vertical Sobel filters, respectively, to area including the group of reconstructed samples. An intra prediction mode (IPM) associated with the group of reconstructed samples may be obtained based on the horizontal gradient and the vertical gradient. In some examples, a direction or an orientation of the group of reconstructed samples may be obtained from the horizontal gradient and the vertical gradient, and the IPM may be determined based on the direction. Subsequently, a histogram of IPMs (or a histogram of gradients (HoG)) (750) may be obtained based on the IPMs obtained from the groups of reconstructed samples associated in the respective areas. The N most frequent IPMs, for example, corresponding to the N tallest histogram bars, may be selected for the current block (701). In an example, the current block (701) may be predicted based on the N IPMs. In an example, the current block (701) may be predicted based on the N IPMs and another IPM (e.g., the planar mode).

The template (711) of the current block may include the neighboring reconstructed samples (e.g., represented by circles in FIG. 7) of the current block (701). The reconstructed samples located on top of the current block (701) may form a top template (712) (e.g., including the 3 rows above the current block (701)), and the reconstructed samples located to the left of the current block (701) may form a left template (713) (e.g., including the 3 columns to the left of the current block (701)). In an example, the reconstructed samples in a top-left corner of the template (711) may be part of the top template (712) and/or part of the left template (713). A template of a current block may include a left template and/or a top template. In the example shown in FIG. 7, the template (711) includes the left template (713) and the top template (712).

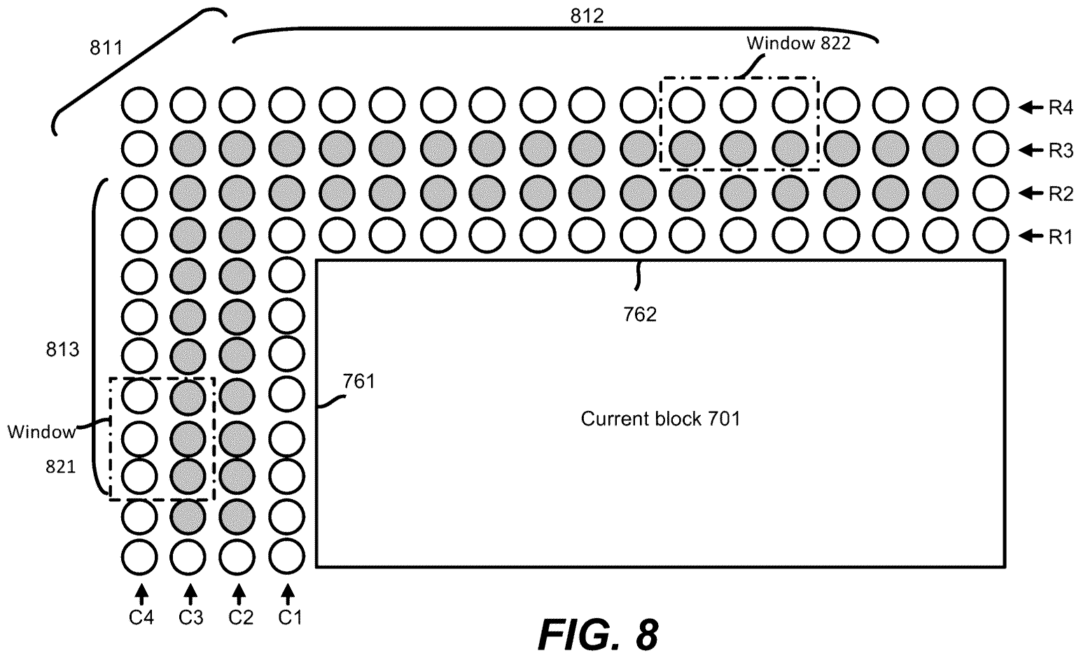

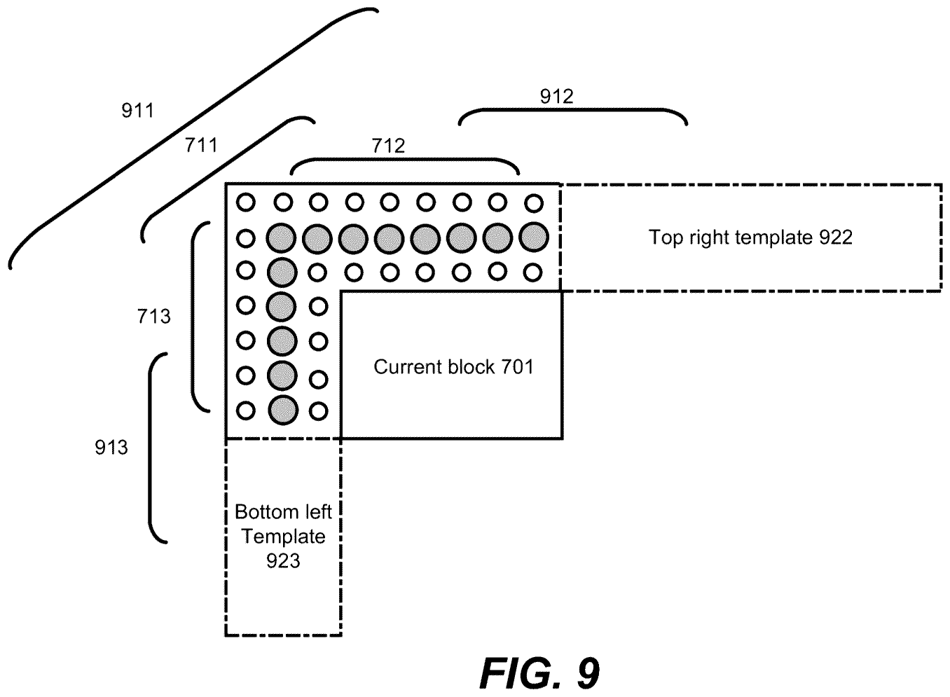

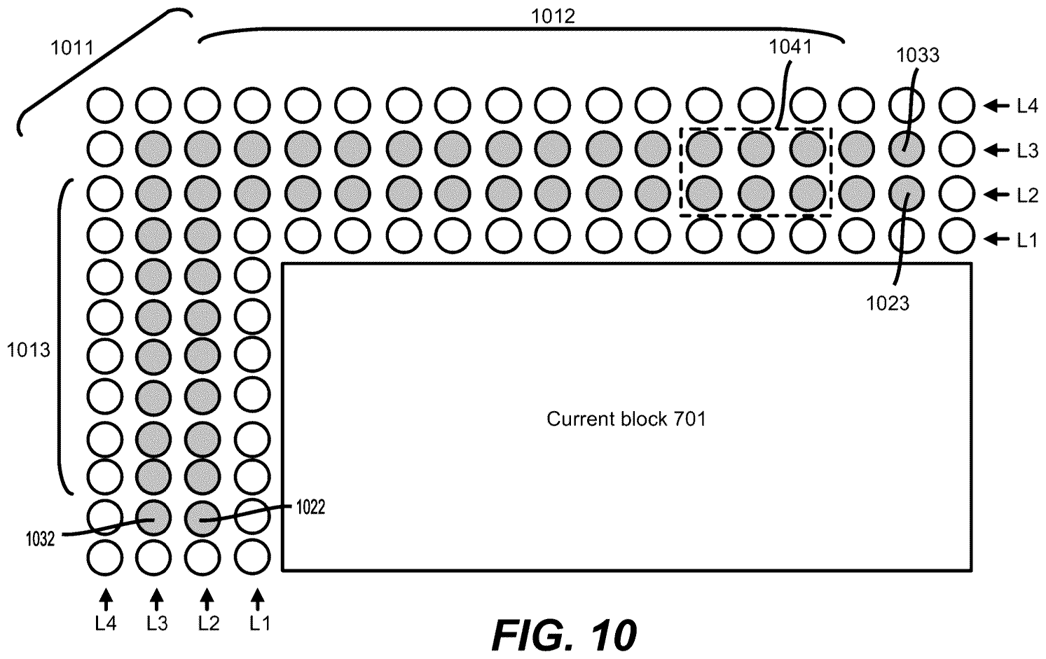

Any suitable number of multiple lines may be included in a template, such as 3 lines (shown in FIGS. 7 and 9), 4 lines (shown in FIGS. 8 and 10), or the like. In the example shown in FIG. 7, the template (711) includes three lines that are adjacent to the current block (701). For example, the left template (713) may include three columns which are part of the lines 1-3. For example, the top template (712) may include three rows which are part of the lines 1-3. The sliding window (721) may be considered as sliding across the template (711), for example, according to a suitable direction and a suitable step size (e.g., one sample at a time). A position (also referred to as a window position) of the sliding window (721) may be indicated by one of the sample positions, such as a center sample, in the sliding window (721). In FIG. 7, the line 2 includes the center samples (e.g., (731) to (743)). FIG. 7 shows two positions of the sliding window (721) indicated by the sample (732) and the sample (739), respectively. In the first case, the sliding window (721) is centered at the sample (732). In the second case, the sliding window (721) is centered at the sample (739).

In the example shown in FIG. 7, the sliding window (721) traverses according to a direction (720) from the bottommost row of the template (711) to the rightmost column of the template (711). The direction (720) may also be described using the center position of the sliding window (721). For example, the sliding window (721) may traverse vertically along the +Y direction from the first sample (e.g., the sample (731) which is the bottommost sample of the line 2) to the sample (736), and then traverse horizontally along the +X direction to the last sample (e.g., the sample (743) which is the rightmost sample of the line 2). Thus, the sliding window (721) may be considered as sliding along the middle line (e.g., the line 2) from the first sample (731) to the last sample (743) of the line 2, and the IPMs may be determined from the groups of reconstructed samples that are associated with the samples (731) to (743), respectively.

In some examples, the sliding window (721) may traverse the middle line (e.g., the line 2) partially, such as from the sample (732) to the sample (742), to increase computational efficiency.

A group of reconstructed samples in the sliding window (721) is associated with each position (e.g., the center position) of the sliding window (721). Referring to FIG. 7, at the sample position (732) of the sliding window (721) (i.e., the sliding window (721) is centered around the sample (732)), the group of reconstructed samples includes the center sample (732) and 8 neighboring samples that surround the center sample (732). At each window position of the sliding window (721), a filter such as a 3×3 Sobel filter is applied to the respective group of reconstructed samples with a center sample in the middle line (e.g., the line 2) of the template (711). The filter, the group of reconstructed samples, and the sliding window (721) are co-located with the same center sample in the middle line (e.g., the line 2) of the template (711), and the window position may be indicated by the center sample position.

At each window position, a direction (e.g., a texture direction) of the corresponding group of reconstructed samples and thus an IPM associated with the group of reconstructed samples may be determined (e.g., estimated) by the following steps.

In the first step, a filter such as a 3×3 Sobel filter may be applied to the group of reconstructed samples at each window position of the sliding window (721), with a sample (e.g., one of the samples (731)-(743)) in the middle line (e.g., the line 2 including the middle row and the middle column samples) as the center sample, to obtain a horizonal gradient Gx and a vertical gradient Gy. The 3×3 Sobel filter may include two kernels such as a 3×3 horizonal Sobel filter and a 3×3 vertical Sobel filter. The 3×3 horizonal Sobel filter may be applied to the group of reconstructed samples in the 3×3 sliding window (721) to obtain the horizonal gradient Gx. The 3×3 vertical Sobel filter may be applied to the group of reconstructed samples in the 3×3 sliding window (721) to obtain the vertical gradient Gy.

In the second step, a ratio of the horizonal gradient Gx over the vertical gradient Gy such as Gx/Gy may be calculated for the group of reconstructed samples at each position of the 3×3 sliding window (721). The ratio of Gx/Gy may indicate intra mode information of a part of the template (711), for example, the intra mode information of the group of reconstructed samples centered at the position (732).

In the third step, the ratio of Gx/Gy may be matched to an IPM. In an example, the IPM may be a conventional IPM such as used in video/imaging coding standards (e.g., HEVC, VCC, and the like). The IPM may be an angular intra prediction mode or a non-angular intra prediction mode. Examples of angular intra prediction modes are described in FIGS. 4A-4B. Examples of non-angular intra prediction modes include the planar mode, the DC mode, the IntraTMP, and the like. The matched IPM associated with the group of reconstructed samples at each position of the sliding window (721) may be stored. In an example, a number of times that an IPM is matched to one or more groups of reconstructed samples at respective position(s) may be determined. Examples of the frequencies of the respective intra prediction modes are indicated or represented by the histogram (750).

In an example, the first, second, and third steps are performed for each group of reconstructed samples in the template (711), for example, for each window position of the sliding window (721) and the IPM frequency information, or histogram (750), may be updated according to the matched IPM at each window position.

The one or more most frequently matched IPMs associated with the derived texture direction(s), for example in the histogram (750), may be used as to generate intra predictor(s). In an example, N is larger than one, the N IPMs may be applied to generate N predictors, and a final predictor of the current block (701) may be determined based on the N predictions.

In an aspect, the Sobel filter may include a horizonal Sobel filter and a vertical Sobel filter. In an example, the Sobel filter is the 3×3 Sobel filter including the horizonal Sobel filter Mₛₓ and the vertical Sobel filter M_{sy} that are defined with a fixed 3×3 shape as follows.

$${M}_{sx} = [ \begin{matrix}- 1 & 0 & 1 \\ - 2 & 0 & 2 \\ - 1 & 0 & 1\end{matrix} ] and {M}_{sy} = [ \begin{matrix}- 1 & - 2 & - 1 \\ 0 & 0 & 0 \\ 1 & 2 & 1\end{matrix} ] \qquad Eq . ( 1 )$$

In related technologies where the Sobel filter is fixed, for example, a filter size is fixed (e.g., fixed to be 3×3) and elements in Mₛₓ and M_{sy} of the Sobel filter are fixed. However, in some examples, a filter that is fixed such as fixed in size, shape, and coefficients (e.g., the fixed 3×3 Sobel filter) may not capture sufficiently accurate directional information from different groups of samples in different areas within the template (711), and thus may result in decreased coding efficiency.

According to an aspect of the disclosure, multiple types of filters or a plurality of filter types may be used to derive gradients associated with the reconstructed samples in the template (711). The multiple types of filters may include the 3×3 Sobel filter described in Eq. (1) and other Sobel-based filters with multiple sizes, multiple shapes, and/or coefficients that may be different from the elements in Mₛₓ and M_{sy} of the 3×3 Sobel filter. Which one of the multiple types of filters is applied to a group of reconstructed samples at a window position in the template (711) may be determined adaptively, for example, in order to derive more accurate directional information from a template area where the sliding window (721) is located.

In an aspect, a filter type may be determined from a plurality of filter types associated with an area in the template (711) of the current block (701). The area may be one of the left template (713) and the top template (712). The plurality of filter types may include filter types in the multiple types of filters. The DIMD mode such as described in FIG. 7 may be applied to the reconstructed samples in the template (711) based on the determined filter type to determine one or more intra prediction modes (e.g., the N IPMs described as above). The current block (701) may be predicted according to the one or more intra prediction modes.

In an aspect, referring to FIG. 7, the one of the left template and the top template may be the left template (713). The plurality of filter types associated with the left template (713) may include the 3×3 Sobel filter described in Eq. (1) and a 3×2 Sobel-based filter. The 3×2 Sobel-based filter may include a horizontal filter Mₗₓ and a vertical filter M_{ly}. In an aspect, a middle row in the horizontal filter Mₗₓ is [0, 0], a sum of each column in the horizontal filter Mₗₓ is 0, and a sum of each row in the vertical filter M_{ly} is 0. In an example, a syntax element such as a flag in a bitstream may indicate which one of the 3×3 Sobel filter and the 3×2 Sobel-based filter is applied to the left template (713), for example, to derive gradients for the reconstructed samples in the left template (713), and the filter type may be determined as one of the 3×3 Sobel filter and the 3×2 Sobel-based filter based on the syntax element. In an example, the flag may be signaled at a block level or in a high-level (e.g., a level higher than the block level) syntax including but is not limited to a slice header, a picture header, a sequence header, a sequence parameter set (SPS), a picture parameter set (PPS), or the like.

In an aspect, the one of the left template and the top template is the left template (713) and may include multiple columns of reconstructed samples (e.g., 3 columns in FIG. 7). The filter type may be the 3×2 Sobel-based filter in the plurality of filter types. The horizontal filter Mₗₓ and the vertical filter M_{ly} may be described in Eq. (2).

$${M}_{lx} = [ \begin{matrix}- 1 & - 3 \\ 0 & 0 \\ 1 & 3\end{matrix} ] and {M}_{ly} = [ \begin{matrix}1 & - 1 \\ 2 & - 2 \\ 1 & - 1\end{matrix} ] \qquad Eq . ( 2 )$$

For each group of reconstructed samples in a 3×2 sliding window that traverses vertically (e.g., by one row at a time) across the multiple columns of reconstructed samples in the left template (713), the 3×2 Sobel-based filter including Mₗₓ and M_{ly} may be applied to the group of reconstructed samples in the 3×2 sliding window to determine an IPM associated with the group of reconstructed samples. The one or more intra prediction modes of the current block (701) may be determined based on the intra prediction modes associated with the groups of reconstructed samples in the left template (713). In an example, the template of the current block (701) only includes the left template (713), the one or more intra prediction modes of the current block (701) may be determined based on the intra prediction modes associated with the groups of reconstructed samples in the left template (713). In an example, the template of the current block (701) includes the left template (713) and the top template (712), the one or more intra prediction modes of the current block (701) may be determined based on the intra prediction modes associated with the groups of reconstructed samples in the left template (713) and intra prediction modes associated with groups of reconstructed samples in the top template (712).

In an example, the 3×2 Sobel-based filter including the horizontal filter (or the 3×2 horizontal Sobel-based filter) Mₗₓ and the vertical filter (or the 3×2 vertical Sobel-based filter) M_{ly} shown in Eq. (2) may be used to derive the horizontal gradient Gx and the vertical gradient Gy, respectively for each group of reconstructed samples in the 3×2 sliding window. A center position in the horizontal filter Mₗₓ is at the position (2, 2) in Mₗₓ. A center position in the vertical filter M_{ly} is at the position (2, 2) in M_{ly}. The center positions in Mₗₓ and M_{ly} correspond to the samples (e.g., the samples (731) to (736)) in the middle column (e.g., a part of the line 2) of the left template (713).

In an example, referring to FIG. 7, the multiple columns of reconstructed samples in the left template (713) include 3 columns.

In an example, the same filters Mₗₓ and May as described in Eq. (2) are used in the left template (713), the center positions in Mₗₓ and M_{ly} may be shifted one sample (or one column) to the left or one sample to the right in the left template (713). In an example, referring to FIG. 7, when shifted to the left, the samples (e.g., samples in Line 3) furthest from a left boundary (761) of the current block (701) may be used as the center positions in Mₗₓ and M_{ly} and may correspond to the center position (e.g., the position (2, 2)) of the 3×2 sliding window. The left template (713) may be extended to the left into four columns and becomes a left template (813), such as shown in FIG. 8. Referring to FIGS. 7-8, columns C1-C3 in FIG. 8 may correspond to the lines 1-3 in FIG. 7, and the left template (813) includes an extension, e.g., the additional column C4. A sample in C3 may be used as a center position in Mₗₓ and M_{ly} and may correspond to a center position (e.g., the position (2, 2)) of a 3×2 sliding window (821) shown in FIG. 8.

Referring to FIG. 8, the left template (813) is adjacent to a current block (701), and a top template (812) is above the current block (701). In an example, a template (811) of the current block (701) includes the left template (813) and the top template (812). The template (811) may include 4 lines that include 4 columns C1 to C4 and 4 rows R1 to R4. In an example, the left template (813) includes the 4 columns C1 to C4 and the top template (812) includes the 4 rows R1 to R4. The multiple columns of reconstructed samples in the left template (813) include 4 columns (e.g., C1 to C4), and the column of reconstructed samples that corresponds to the center positions in Mₗₓ and M_{ly} is one of two center columns (e.g., C2 and C3) of the four columns (e.g., C1 to C4).

In an example, when shifted to the right, the samples (e.g., samples in C2 or C1) closest to the left boundary (861) of the current block (701) are used as the center positions in Mₗₓ and M_{ly} and may correspond to the center position (e.g., the position (2, 2)) of the 3×2 sliding window. In an example, referring to FIG. 7, when shifted to the right, the samples (e.g., samples in the line 1) closest to the left boundary (761) of the current block (701) are used as the center positions in Mₗₓ and M_{ly} and may correspond to the center position (e.g., the position (2, 2)) of the 3×2 sliding window.

In an aspect, referring to FIG. 7, the one of the top template (712) and the left template (713) is the top template (712). The plurality of filter types may include the 3×3 Sobel filter such as described in Eq. 1 and a 2×3 Sobel-based filter. The 2×3 Sobel-based filter may include a horizontal filter Mₜₓ and a vertical filter M_{ty}. A middle column in M_{ty} may be

$$[ \begin{matrix}0 \\ 0\end{matrix} ] ,$$

a sum of each row in M_{ty} may be 0, and a sum of each column in Mₜₓ may be 0. In an example, a syntax element such as a flag in the bitstream may indicate which one of the 3×3 Sobel filter and the 2×3 Sobel-based filter is applied to the top template (712), for example, to derive gradients for the reconstructed samples in the top template (712). The filter type may be determined as one of the 3×3 Sobel filter and the 2×3 Sobel-based filter based on the syntax element, which may be signaled at the block level or a level higher than the block level, such as the slice header, the picture header, the sequence header, the SPS, the PPS, or the like.

In an aspect, referring back to FIG. 7, the one of the top template (712) and the left template (713) is the top template (712) and include multiple rows of reconstructed samples (e.g., 3 rows in FIG. 7). The filter type is the 2×3 Sobel-based filter in the plurality of filter types. The horizontal filter Mₜₓ and the vertical filter M_{ty} may be described in Eq. (3).

$${M}_{tx} = [ \begin{matrix}- 1 & - 2 & - 1 \\ 1 & 2 & 1\end{matrix} ] and {M}_{ty} = [ \begin{matrix}1 & 0 & - 1 \\ 3 & 0 & - 3\end{matrix} ] \qquad Eq . ( 3 )$$

For each group of reconstructed samples in a 2×3 sliding window that traverses horizontally (e.g., by one column at a time) across the multiple rows of reconstructed samples in the top template (712), the 2×3 Sobel-based filter including Mₜₓ and M_{ty} may be applied to the group of reconstructed samples in the 2×3 sliding window to determine an IPM associated with the group of reconstructed samples in the 2×3 sliding window. The one or more intra prediction modes of the current block (701) may be determined based on the intra prediction modes associated with the groups of the reconstructed samples in the top template (712). In an example, the template of the current block (701) only includes the top template (712), the one or more intra prediction modes of the current block (701) may be determined based on the intra prediction modes associated with the groups of reconstructed samples in the top template (712). In an example, the template of the current block (701) includes the left template (713) and the top template (712), the one or more intra prediction modes of the current block (701) may be determined based on the intra prediction modes associated with the groups of reconstructed samples in the left template (713) and the intra prediction modes associated with groups of reconstructed samples in the top template (712).

In an example, the 2×3 Sobel-based filter including Mₜₓ and M_{ty} is used to derive the horizontal gradient Gx and the vertical gradient Gy for each group of reconstructed samples in the 2×3 sliding window sliding across the top template (712). A center position of the horizontal filter Mₜₓ is at the position (2, 2) in Mₜₓ. A center position of the vertical filter M_{ty} is at the position (2, 2) in M_{ty}. The center positions in Mₜₓ and M_{ty} correspond to the samples (e.g., the samples (736) to (743)) in the middle row (e.g., a part of the line 2) of the top template (712).

In an example, referring to FIG. 7, the multiple rows of reconstructed samples in the top template (712) include 3 rows.

In an example, referring to FIG. 8, the multiple rows of reconstructed samples in the top template (812) include 4 rows (e.g., R1 to R4), and the row of reconstructed samples that corresponds to the center positions in Mₜₓ and M_{ty} is one of two center rows (e.g., R2 and R3) of the four rows (e.g., R1 to R4).

In an example, the filters Mₜₓ and M_{ty} as described in Eq. (3) are used in the top template (712), the center positions in Mₜₓ and M_{ty} may be shifted one sample (or one row) upward or one sample downward in the top template (712). In an example, referring to FIG. 7, when shifted upward, the samples (e.g., samples in Line 3) furthest from a top boundary (762) of the current block (701) may be used as the center positions in Mₜₓ and M_{ty} and may correspond to the center position (e.g., the position (2, 2)) of the 2×3 sliding window. Thus, the top template (712) may be extended upward by a row (e.g., R4 in FIG. 8) to form the top template (812) including 4 rows. Referring to FIG. 8, the samples (e.g., samples in R4) furthest from the top boundary (762) of the current block (701) may be used as the center positions in Mₜₓ and M_{ty} and may correspond to the center position (e.g., the position (2, 2)) of the 2×3 sliding window, such as a window (822) in FIG. 8.

In an example, referring to FIG. 7, when shifted downward, the samples (e.g., samples in the line 1) closest to a top boundary (762) of the current block (701) are used as the center positions in Mₜₓ and M_{ty} and may correspond to the center position (e.g., the position (2, 2)) of the 2×3 sliding window. In an example, referring to FIG. 8, in addition to the samples in R3, the samples (e.g., samples in R2 or R1) may be used as the center positions in Mₜₓ and M_{ty} and may correspond to the center position (e.g., the position (2, 2)) of the 2×3 sliding window.

In an aspect, the current block (701) is a luma block in a luma component, and the filter type may be determined adaptively from the plurality of filter types as described in the disclosure. In an example, when the DIMD mode is applied to a block (e.g., a chroma block) that is not in the luma component, a fixed filter such as the 3×3 Sobel filter described in Eq. (1) is applied to the block.

In an aspect, the current block (701) may be a luma block in a luma component or a chroma block in a chroma component, and the filter type may be determined adaptively from the plurality of filter types as described in the disclosure. For example, the filter type may be selected from the filters described in Eqs. (1)-(2) when the filter is to be applied to the left template of the current block (e.g., a chroma block or a luma block). For example, the filter type may be selected from the filters described in Eqs. (1) and (3) when the filter is to be applied to the top template of the current block (e.g., a chroma block or a luma block).

In an aspect, the template size may be extended to the top right of the current block (701) and/or to the bottom left of the current block (701), as shown in FIG. 9. As described in FIG. 7, the template (711) may include the top template (712) and the left template (713). FIG. 9 shows an example of extending the template (711) of the current block (701) to generate a template (911) according to an aspect of the disclosure. The template (911) includes a top template (912) and a left template (913). The top template (912) may include the top template (712) and a top right template (922) which may include reconstructed samples that are above and to the right of the current block (701). The left template (913) may include the left template (713) and a bottom left template (923) which may include reconstructed samples that are below and to the left of the current block (701).

An extended size of the top-right template (922) and the bottom left template (923) may be based on a width and a height of the current block (701). For example, a width of the top-right template (922) increases with the width of the current block (701), and a height of the top-right template (922) is identical to a height of the top template (712). For example, a height of the bottom left template (923) increases with the height of the current block (701), and a width of the bottom left template (923) is identical to a width of the left template (713).

In an aspect, the filter type such as the filter shape (e.g., whether the filter is 3×3, 3×2, or 2×3) may be selected depending on coded information or known information (e.g., information available to the decoder), including but is not limited to (i) locations of the respective samples in the template (711) relative to the current block (701), (ii) a block size of the current block (701), (iii) a block shape of the current block (701), (iv) a location of the current block (701) in one of the current picture (700) and a current coding tree unit (CTU), (v) reference (neighboring samples) lines, and/or the like. For example, when the reconstructed samples are in the top template (712), the 2×3 Sobel-based filter is used, and when the reconstructed samples are in the left template (713), the 3×2 Sobel-based filter is used.

In an aspect, the template (711) includes the multiple lines of the reconstructed samples such as the lines 1-3. For each group of reconstructed samples in the sliding window (721) that traverses the middle line (e.g., the line 2) across the template (711), a respective filter type may be applied to the group of reconstructed samples to determine an intra prediction mode associated with the group of reconstructed samples. The one or more intra prediction modes of the current block (701) may be determined based on the intra prediction modes associated with the groups of reconstructed samples in the template (711). In an example, the sliding window (721) may traverse the middle line (e.g., the line 2) completely from the bottommost sample (e.g., the sample (731)) of the middle line to the rightmost sample (e.g., the sample (743)) of the middle line, and thus 13 intra prediction modes may be determined corresponding to 13 positions of the sliding window (721) from the sample (731) to the sample (743).

In another example, the sliding window (721) may traverse a subset of samples in the middle line (e.g., the line 2), for example, from the sample (732) to the sample (742), and thus 11 intra prediction modes may be determined corresponding to 11 positions of the sliding window (721) from the sample (732) to the sample (742). Thus, in this example, the filters used to calculate the gradients Gx and Gy are not applied to each reconstructed sample in the line 2 in the template (711), but are only applied to a subset (the samples (732) to (742)) of the reconstructed samples in the line 2 excluding the end samples (731) and (743).

In an aspect, referring to FIG. 7, the sliding window (721) traverses the line 2 in the template (711) of the current block (701), and only one line (e.g., the line 2) of reconstructed samples may be used as the center positions and are filtered. The IPMs associated with the positions (e.g., the samples (731) to (743) in the line 2) of the sliding window (721) may be obtained. In addition to a single line shown in FIG. 7, the sliding window may traverse each of multiple lines in a template of a current block, and thus the multiple lines of reconstructed samples may be considered as the center positions and are filtered. Thus, more IPMs may be obtained, and the one or more IPMs determined from the histogram may be more accurate.

FIG. 10 shows an example of using multiple lines of reconstructed samples as center positions of the filter(s). The current block (701) may have a template (1011) that includes four adjacent lines L1-L4 of reconstructed samples. The DIMD method may be applied to determine the one or more IPMs that may be used to predict the current block (701) with filter type(s) selected from the plurality of filter types. Each of two middle lines (e.g., L2 and L3) of the four adjacent lines L1-L4 may be used as the center positions of the filters to obtain gradients and thus to determine IPMs. For each of the two middle lines (e.g., L2 and L3), a filter type may be applied to each group of reconstructed samples in a sliding window (1041) to determine an intra prediction mode associated with the group of reconstructed samples in the sliding window (1041) that traverses the middle line (e.g., one sample at a time). For example, the sliding window (1041) traverses from a sample (1032) to a sample (1033) along L3. At each position of the sliding window (1041), a filter (e.g., the 3×3 Sobel filter, the 3×2 Sobel-based filter, or the 2×3 Sobel-based filter) is applied to the group of reconstructed samples in the sliding window (1041) to determine gradients Gx and Gy. Thus, an IPM is obtained based on the gradients Gx and Gy. The same process is repeated for L2, for example, as the sliding window (1041) traverses from a sample (1022) to a sample (1023) along L2. IPM frequency information, or a histogram, similar to the IPM frequency information of histogram (750) may be determined based on the IPMs obtained. The one or more intra prediction modes of the current block (701) may be determined from the intra prediction modes associated with the groups of reconstructed samples in the template (1011).

In an example, a shape and/or a size of the sliding window (1041) may change. For example, when the sliding window (1041) is in a left template (1013) of the template (1011), the sliding window (1041) may have a size of 3×2, and the 3×2 Sobel-based filter may be applied. When the sliding window (1041) is in a top template (1012) of the template (1011), the sliding window (1041) may have a size of 2×3, and the 2×3 Sobel-based filter may be applied. In an example, the template (1011) is the template (811).

The term “DIMD” may refer to the DIMD mode or a variant, such as described in FIGS. 7-12 in the disclosure. The term “IntraTMP mode” may refer to the IntraTMP mode or a variant.

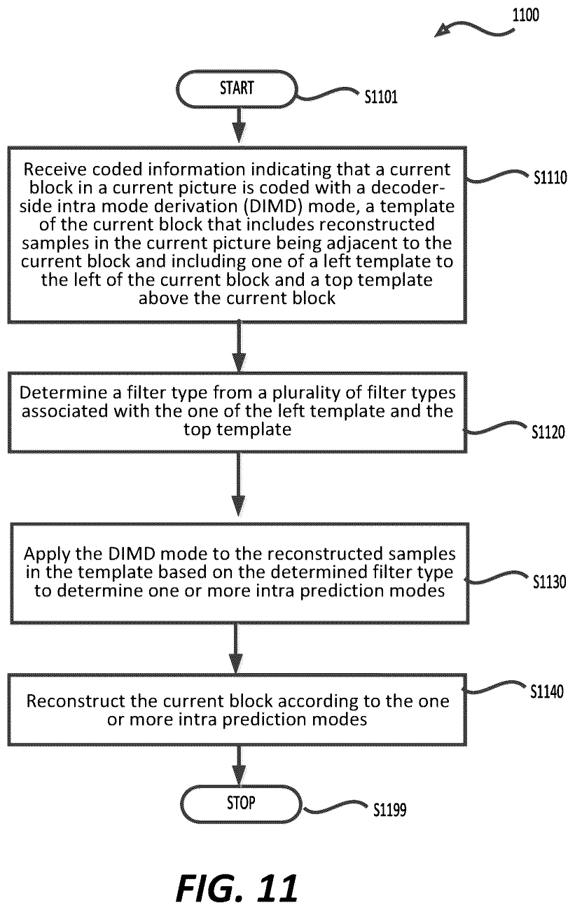

FIG. 11 shows a flow chart outlining a process (1100) according to an aspect of the disclosure. The process (1100) may be used in an apparatus, such as a video decoder. In various aspects, the process (1100) is executed by processing circuitry, such as the processing circuitry that performs functions of the video decoder (110), the processing circuitry that performs functions of the video decoder (210), and the like. In some aspects, the process (1100) is implemented in software instructions, thus when the processing circuitry executes the software instructions, the processing circuitry performs the process (1100). The process starts at (S1101) and proceeds to (S1110).

At (S1110), coded information indicating that a current block in a current picture is coded with a decoder-side intra mode derivation (DIMD) mode is received. A template of the current block is adjacent to the current block and includes reconstructed samples in the current picture. The template may include one of a left template to the left of the current block and a top template above the current block.

At (S1120), a filter type is determined from a plurality of filter types associated with the one of the left template and the top template.

In an aspect, the one of the left template and the top template is the left template. The plurality of filter types include a 3×3 Sobel filter and a 3×2 Sobel-based filter, the 3×2 Sobel-based filter includes a horizontal filter Mₗₓ and a vertical filter M_{ly}, a middle row in Mₗₓ is [0, 0], a sum of each column in Mₗₓ is 0, and a sum of each row in M_{ly} is 0. A syntax element in the coded information indicates which one of the 3×3 Sobel filter and the 3×2 Sobel-based filter is applied to the left template and the filter type is determined as one of the 3×3 Sobel filter and the 3×2 Sobel-based filter based on the syntax element.

In an aspect, the one of the left template and the top template is the top template. The plurality of filter types include a 3×3 Sobel filter and a 2×3 Sobel-based filter, the 2×3 Sobel-based filter includes a horizontal filter Mₜₓ and a vertical filter M_{ty}, a middle column in M_{ty} is

$$[ \begin{matrix}0 \\ 0\end{matrix} ] ,$$

a sum of each row in M_{ty} is 0, and a sum of each column in Mₜₓ is 0. A syntax element in the coded information indicates which one of the 3×3 Sobel filter and the 2×3 Sobel-based filter is applied to the top template and the filter type is determined as one of the 3×3 Sobel filter and the 2×3 Sobel-based filter based on the syntax element.

At (S1130), the DIMD mode is applied to the reconstructed samples in the template based on the determined filter type to determine one or more intra prediction modes.

At (S1140), the current block is reconstructed according to the one or more intra prediction modes.

Then, the process proceeds to (S1199) and terminates.

The process (1100) may be suitably adapted. Step(s) in the process (1400) may be modified and/or omitted. Additional step(s) may be added. Any suitable order of implementation may be used.

In an example, the one of the left template and the top template is the left template and includes multiple columns of reconstructed samples, the filter type is a 3×2 Sobel-based filter in the plurality of filter types, and the 3×2 Sobel-based filter includes a horizontal filter Mₗₓ that is

$$[ \begin{matrix}- 1 & - 3 \\ 0 & 0 \\ 1 & 3\end{matrix} ]$$

and a vertical filter M_{ly} that is

$$[ \begin{matrix}1 & - 1 \\ 2 & - 2 \\ 1 & - 1\end{matrix} ] .$$

For each group of reconstructed samples in a 3×2 sliding window that traverses the left template one row at a time across the multiple columns of samples, Mₗₓ and M_{ly} are applied to the respective group of reconstructed samples in the 3×2 sliding window to determine an intra prediction mode associated with the respective group of reconstructed samples in the sliding window. The one or more intra prediction modes of the current block may be determined based on the determined intra prediction modes associated with the respective groups of the reconstructed samples in the left template.

In an example, the multiple columns of reconstructed samples are four columns.

In an example, the one of the left template and the top template is the top template and includes multiple rows of reconstructed samples, the filter type is a 2×3 Sobel-based filter in the plurality of filter types, and the 2×3 Sobel-based filter includes that a horizontal filter Mₜₓ that is

$$[ \begin{matrix}- 1 & - 2 & - 1 \\ 1 & 2 & 1\end{matrix} ]$$

and a horizontal filter M_{ty} that is

$$[ \begin{matrix}1 & 0 & - 1 \\ 3 & 0 & - 3\end{matrix} ] .$$

For each group of reconstructed samples in a 2×3 sliding window that traverses the top template one column at a time across the multiple rows of samples, Mₜₓ and M_{ty} are applied to the respective group of reconstructed samples in the 2×3 sliding window to determine an intra prediction mode associated with the respective group of reconstructed samples in the sliding window. The one or more intra prediction modes of the current block may be determined based on the determined intra prediction modes associated with the respective groups of the reconstructed samples in the top template.

In an example, the multiple rows of samples are four rows.

In an example, the template includes the top template and the left template, the top template includes the reconstructed samples that are directly above the current block and the reconstructed samples that are above and to the right of the current block, and the left template includes the reconstructed samples that are directly to the left of the current block and the reconstructed samples that are below and to the left of the current block.

In an example, the filter type is determined based on one of (i) locations of the respective samples in the template relative to the current block, (ii) a block size of the current block, (iii) a block shape of the current block, (iv) a location of the current block in one of the current picture and a current coding tree unit (CTU), and (v) reference lines.

In an example, the template includes multiple lines of the reconstructed samples. For each group of reconstructed samples in a sliding window that traverses a middle line one sample at a time across the multiple lines, a filter type is applied to the respective group of the reconstructed samples in the sliding window to determine an intra prediction mode associated with the respective group of the reconstructed samples in the sliding window. The one or more intra prediction modes of the current block may be determined based on the determined intra prediction modes associated with the respective groups of the reconstructed samples in the template. The sliding window traverses the middle line except one or more of the rightmost sample of the middle line and the bottommost sample of the middle line.

In an example, the template includes four adjacent lines of the reconstructed samples. For each of two middle lines of the four adjacent lines of the reconstructed samples, a filter type is applied to each group of reconstructed samples in a sliding window to determine an intra prediction mode associated with the group of reconstructed samples in the sliding window that traverses the middle line one sample at a time. The one or more intra prediction modes of the current block may be determined from the determined intra prediction modes associated with the respective groups of the reconstructed samples in the template.

In an example, the current block is a luma block.

In an example, the current block is one of a luma block and a chroma block.

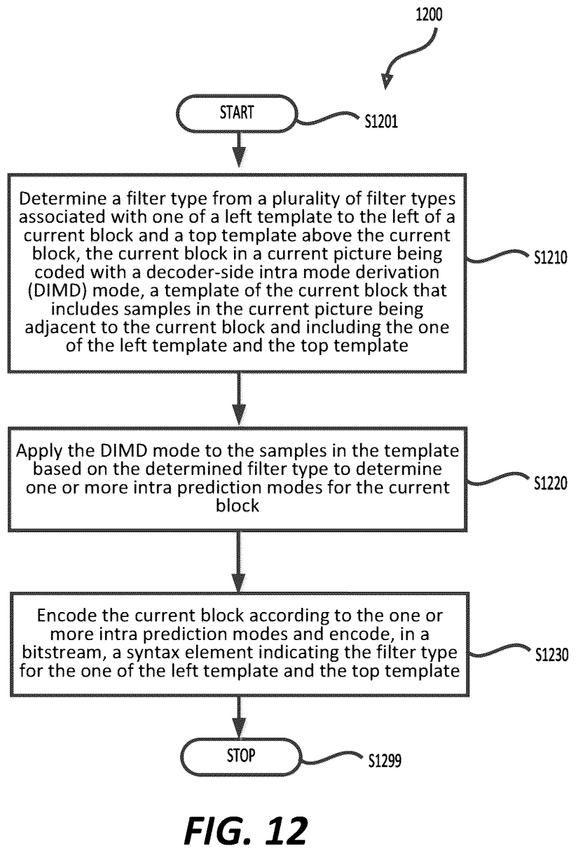

FIG. 12 shows a flow chart outlining a process (1200) according to an aspect of the disclosure. The process (1200) may be used in a video encoder. In various aspects, the process (1200) is executed by processing circuitry, such as the processing circuitry that performs functions of the video encoder (103), the processing circuitry that performs functions of the video encoder (303), and the like. In some aspects, the process (1200) is implemented in software instructions, thus when the processing circuitry executes the software instructions, the processing circuitry performs the process (1200). The process starts at (S1201) and proceeds to (S1210).

At (S1210), a filter type is determined from a plurality of filter types associated with one of a left template to the left of a current block and a top template above the current block. The current block in a current picture is coded with a decoder-side intra mode derivation (DIMD) mode. A template of the current block includes samples in the current picture. The template is adjacent to the current block and includes the one of the left template and the top template. In an example, the samples in the template of the current block includes multiple lines of samples in the current picture.

When the one of the left template and the top template is the left template, the plurality of filter types include a 3×3 Sobel filter and a 3×2 Sobel-based filter, the 3×2 Sobel-based filter indicates a horizontal filter Mₗₓ and a vertical filter M_{ly}, a middle row in Mₗₓ is [0, 0], a sum of each column in Mₗₓ is 0, and a sum of each row in M_{ly} is 0, and the syntax element for the left template indicates one of the 3×3 Sobel filter and the 3×2 Sobel-based filter for the left template.

When the one of the left template and the top template is the top template, the plurality of filter types include a 3×3 Sobel filter and a 2×3 Sobel-based filter, the 2×3 Sobel-based filter indicates a horizontal filter Mₜₓ and a vertical filter M_{ty}, a middle column in M_{ty} is

$$[ \begin{matrix}0 \\ 0\end{matrix} ] ,$$

a sum of each row in M_{ty} is 0, and a sum of each column in Mₜₓ is 0, and the syntax element for the top template indicates one of the 3×3 Sobel filter and the 2×3 Sobel-based filter for the top template.

In an example, the template includes the top template and the left template, the top template includes the samples that are directly above the current block and the samples that are above and to the right of the current block, the left template includes the samples that are directly to the left of the current block and the samples that are below and to the left of the current block.

At (S1220), the DIMD mode is applied to the samples in the template based on the determined filter type to determine one or more intra prediction modes for the current block.

In an example, the template includes four adjacent lines of the samples. To apply the DIMD mode, for each of two middle lines of the four adjacent lines of the samples, a filter type is applied to each group of reconstructed samples in a sliding window to determine an intra prediction mode associated with the group of reconstructed samples in the sliding window that traverses the middle line one sample at a time. The one or more intra prediction modes may be determined from the intra prediction modes associated with the center positions that are the two middle lines.

At (S1230), the current block is encoded using the one or more intra prediction modes and a syntax element indicating the filter type for the one of the left template and the top template may be encoded in a bitstream.

Then, the process proceeds to (S1299) and terminates.

The process (1200) may be suitably adapted. Step(s) in the process (1200) may be modified and/or omitted. Additional step(s) may be added. Any suitable order of implementation may be used.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an aspect, the bitstream includes a first syntax element indicating that a current block in a current picture is coded with a decoder-side intra mode derivation (DIMD) mode. A template of the current block that includes reconstructed samples in the current picture is adjacent to the current block and includes one of a left template to the left of the current block and a top template above the current block.

In an aspect, the format rule specifies that a filter type is determined from a plurality of filter types associated with the one of the left template and the top template, the DIMD mode is applied to the reconstructed samples in the template based on the determined filter type to determine one or more intra prediction modes for the current block, and the current block is reconstructed according to the one or more intra prediction modes.

Methods, aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

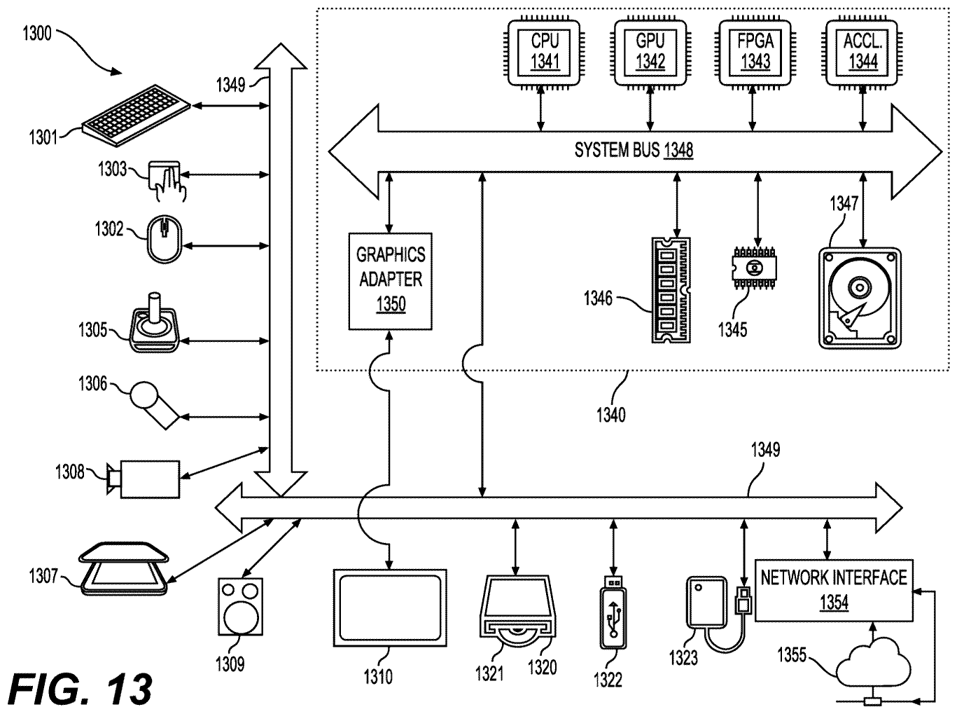

The techniques described above, may be implemented as computer software using computer-readable instructions and physically stored in one or more computer-readable media. For example, FIG. 13 shows a computer system (1300) suitable for implementing certain aspects of the disclosed subject matter.

The computer software may be coded using any suitable machine code or computer language, that may be subject to assembly, compilation, linking, or like mechanisms to create code comprising instructions that may be executed directly, or through interpretation, micro-code execution, and the like, by one or more computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 13 for computer system (1300) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1300).

Computer system (1300) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1301), mouse (1302), trackpad (1303), touch screen (1310), data-glove (not shown), joystick (1305), microphone (1306), scanner (1307), camera (1308).

Computer system (1300) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1310), data-glove (not shown), or joystick (1305), but there may also be tactile feedback devices that do not serve as input devices), audio output devices (such as: speakers (1309), headphones (not depicted)), visual output devices (such as screens (1310) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1300) may also include human accessible storage devices and their associated media such as optical media including CD/DVD ROM/RW (1320) with CD/DVD or the like media (1321), thumb-drive (1322), removable hard drive or solid state drive (1323), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1300) may also include an interface (1354) to one or more communication networks (1355). Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1349) (such as, for example USB ports of the computer system (1300)); others are commonly integrated into the core of the computer system (1300) by attachment to a system bus as described below (for example Ethernet interface into a PC computer system or cellular network interface into a smartphone computer system). Using any of these networks, computer system (1300) may communicate with other entities. Such communication may be uni-directional, receive only (for example, broadcast TV), uni-directional send-only (for example CANbus to certain CANbus devices), or bi-directional, for example to other computer systems using local or wide area digital networks. Certain protocols and protocol stacks may be used on each of those networks and network interfaces as described above.

Aforementioned human interface devices, human-accessible storage devices, and network interfaces may be attached to a core (1340) of the computer system (1300).

The core (1340) may include one or more Central Processing Units (CPU) (1341), Graphics Processing Units (GPU) (1342), specialized programmable processing units in the form of Field Programmable Gate Areas (FPGA) (1343), hardware accelerators for certain tasks (1344), graphics adapters (1350), and so forth. These devices, along with Read-only memory (ROM) (1345), Random-access memory (1346), internal mass storage such as internal non-user accessible hard drives, SSDs, and the like (1347), may be connected through a system bus (1348). In some computer systems, the system bus (1348) may be accessible in the form of one or more physical plugs to enable extensions by additional CPUs, GPU, and the like. The peripheral devices may be attached either directly to the core's system bus (1348), or through a peripheral bus (1349). In an example, the screen (1310) may be connected to the graphics adapter (1350). Architectures for a peripheral bus include PCI, USB, and the like.

CPUs (1341), GPUs (1342), FPGAs (1343), and accelerators (1344) may execute certain instructions that, in combination, may make up the aforementioned computer code. That computer code may be stored in ROM (1345) or RAM (1346). Transitional data may also be stored in RAM (1346), whereas permanent data may be stored for example, in the internal mass storage (1347). Fast storage and retrieve to any of the memory devices may be enabled through the use of cache memory, that may be closely associated with one or more CPU (1341), GPU (1342), mass storage (1347), ROM (1345), RAM (1346), and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture (1300), and specifically the core (1340) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (1340) that are of non-transitory nature, such as core-internal mass storage (1347) or ROM (1345). The software implementing various aspects of the present disclosure may be stored in such devices and executed by core (1340). A computer-readable medium may include one or more memory devices or chips, according to particular needs. The software may cause the core (1340) and specifically the processors therein (including CPU, GPU, FPGA, and the like) to execute particular processes or particular parts of particular processes described herein, including defining data structures stored in RAM (1346) and modifying such data structures according to the processes defined by the software. In addition or as an alternative, the computer system may provide functionality as a result of logic hardwired or otherwise embodied in a circuit (for example: accelerator (1344)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An apparatus for video decoding, comprising:
processing circuitry configured to:
receive coded information indicating that a current block in a current picture is coded with a decoder-side intra mode derivation (DIMD) mode, a template of the current block that includes reconstructed samples in the current picture being adjacent to the current block and including one of a left template to the left of the current block and a top template above the current block;
determine a filter type from a plurality of filter types associated with the one of the left template and the top template;
apply the DIMD mode to the reconstructed samples in the template based on the determined filter type to determine one or more intra prediction modes for the current block; and
reconstruct the current block according to the one or more intra prediction modes.

2. The apparatus of claim 1, wherein
the one of the left template and the top template is the left template;
the plurality of filter types includes a 3×3 Sobel filter and a 3×2 Sobel-based filter, the 3×2 Sobel-based filter includes a horizontal filter Mₗₓ and a vertical filter M_{ly}, a middle row in Mₗₓ is [0, 0], a sum of each column in Mₗₓ is 0, and a sum of each row in M_{ly} is 0;
a syntax element in the coded information indicates which one of the 3×3 Sobel filter and the 3×2 Sobel-based filter is applied to the left template; and
the processing circuitry is configured to determine the filter type as one of the 3×3 Sobel filter and the 3×2 Sobel-based filter based on the syntax element.

3. The apparatus of claim 1, wherein
the one of the left template and the top template is the top template;
the plurality of filter types includes a 3×3 Sobel filter and a 2×3 Sobel-based filter, the 2×3 Sobel-based filter includes a horizontal filter Mₜₓ and a vertical filter M_{ty}, a middle column in M_{ty} is
$$[ \begin{matrix}0 \\ 0\end{matrix} ] ,$$
a sum of each row in M_{ty} is 0, and a sum of each column in Mₜₓ is 0;
a syntax element in the coded information indicates which one of the 3×3 Sobel filter and the 2×3 Sobel-based filter is applied to the top template; and
the processing circuitry is configured to determine the filter type as one of the 3×3 Sobel filter and the 2×3 Sobel-based filter based on the syntax element.

4. The apparatus of claim 1, wherein
the one of the left template and the top template is the left template and includes multiple columns of reconstructed samples;
the filter type is a 3×2 Sobel-based filter in the plurality of filter types;
the 3×2 Sobel-based filter includes a horizontal filter Mₗₓ that is
$$[ \begin{matrix}- 1 & - 3 \\ 0 & 0 \\ 1 & 3\end{matrix} ]$$
and a vertical filter M_{ly} that is
$$[ \begin{matrix}1 & - 1 \\ 2 & - 2 \\ 1 & - 1\end{matrix} ] ;$$
and
for each group of reconstructed samples in a 3×2 sliding window that traverses the left template one row at a time across the multiple columns of samples, the processing circuitry is configured to apply Mₗₓ and M_{ly} to the respective group of reconstructed samples in the 3×2 sliding window to determine an intra prediction mode associated with the respective group of reconstructed samples in the sliding window and determine the one or more intra prediction modes of the current block based on the determined intra prediction modes associated with the respective groups of reconstructed samples in the left template.

5. The apparatus of claim 1, wherein
the one of the left template and the top template is the top template and includes multiple rows of reconstructed samples;
the filter type is a 2×3 Sobel-based filter in the plurality of filter types:
the 2×3 Sobel-based filter includes that a horizontal filter Mₜₓ that is
$$[ \begin{matrix}- 1 & - 2 & - 1 \\ 1 & 2 & 1\end{matrix} ]$$
and a horizontal filter M_{ty} that is
$$[ \begin{matrix}1 & 0 & - 1 \\ 3 & 0 & - 3\end{matrix} ] ;$$
and
for each group of reconstructed samples in a 2×3 sliding window that traverses the top template one column at a time across the multiple rows of samples, the processing circuitry is configured to apply Mₜₓ and M_{ty} to the respective group of reconstructed samples in the 2×3 sliding window to determine an intra prediction mode associated with the respective group of reconstructed samples in the sliding window and determine the one or more intra prediction modes of the current block based on the determined intra prediction modes associated with the respective groups of reconstructed samples in the top template.

6. The apparatus of claim 1, wherein the template includes the top template and the left template, the top template includes the reconstructed samples that are directly above the current block and the reconstructed samples that are above and to the right of the current block, the left template includes the reconstructed samples that are directly to the left of the current block and the reconstructed samples that are below and to the left of the current block.

7. The apparatus of claim 1, wherein the processing circuitry is configured to determine the filter type based on one of (i) locations of the respective samples in the template relative to the current block, (ii) a block size of the current block, (iii) a block shape of the current block, (iv) a location of the current block in one of the current picture and a current coding tree unit (CTU), and (v) reference lines.

8. The apparatus of claim 1, wherein
the template includes four adjacent lines of the reconstructed samples;
for each of two middle lines of the four adjacent lines of the reconstructed samples,
the processing circuitry is configured to apply a filter type to each group of reconstructed samples in a sliding window to determine an intra prediction mode associated with the group of reconstructed samples in the sliding window that traverses the middle line one sample at a time; and
the processing circuitry is configured to determine the one or more intra prediction modes of the current block from the determined intra prediction modes associated with the respective groups of reconstructed samples in the template.

9. A method for video encoding, comprising:
determining a filter type from a plurality of filter types associated with one of a left template to the left of a current block and a top template above the current block, the current block in a current picture being coded with a decoder-side intra mode derivation (DIMD) mode, a template of the current block that includes samples in the current picture being adjacent to the current block and including the one of the left template and the top template;
applying the DIMD mode to the samples in the template based on the determined filter type to determine one or more intra prediction modes for the current block;
encoding the current block according to the one or more intra prediction modes; and
encoding, in a bitstream, a syntax element indicating the filter type for the one of the left template and the top template.

10. The method of claim 9, wherein
when the one of the left template and the top template is the left template, the plurality of filter types include a 3×3 Sobel filter and a 3×2 Sobel-based filter, the 3×2 Sobel-based filter indicates a horizontal filter Mₗₓ and a vertical filter M_{ty}, a middle row in Mₗₓ is [0, 0], a sum of each column in Mₗₓ is 0, and a sum of each row in M_{ly} is 0, and the syntax element for the left template indicates one of the 3×3 Sobel filter and the 3×2 Sobel-based filter for the left template.

11. The method of claim 9, wherein
when the one of the left template and the top template is the top template, the plurality of filter types include a 3×3 Sobel filter and a 2×3 Sobel-based filter, the 2×3 Sobel-based filter indicates a horizontal filter Mₜₓ and a vertical filter M_{ty}, a middle column in M_{ty} is
$$[ \begin{matrix}0 \\ 0\end{matrix} ] ,$$
a sum of each row in M_{ty} is 0, and a sum of each column in Mₜₓ is 0, and the syntax element for the top template indicates one of the 3×3 Sobel filter and the 2×3 Sobel-based filter for the top template.

12. The method of claim 9, wherein the template includes the top template and the left template, the top template includes the samples that are directly above the current block and the samples that are above and to the right of the current block, the left template includes the samples that are directly to the left of the current block and the samples that are below and to the left of the current block.

13. The method of claim 9, wherein
the template includes four adjacent lines of the samples; and
the applying the DIMD mode includes
for each of two middle lines of the four adjacent lines of the samples, applying a filter type to each group of samples in a sliding window to determine an intra prediction mode associated with the group of samples in the sliding window that traverses the middle line one sample at a time; and
determining the one or more intra prediction modes from the intra prediction modes associated with the respective groups of samples in the template.

14. The method of claim 9, wherein
the one of the left template and the top template is the left template and includes multiple columns of samples;
the filter type is a 3×2 Sobel-based filter in the plurality of filter types;
the 3×2 Sobel-based filter includes a horizontal filter Mₗₓ that is
$$[ \begin{matrix}- 1 & - 3 \\ 0 & 0 \\ 1 & 3\end{matrix} ]$$
and a vertical filter M_{ly} that is
$$[ \begin{matrix}1 & - 1 \\ 2 & - 2 \\ 1 & - 1\end{matrix} ] ;$$
and
the applying the DIMD mode includes, for each group of samples in a 3×2 sliding window that traverses the left template one row at a time across the multiple columns of samples, applying Mₗₓ and M_{ly} to the respective group of samples in the 3×2 sliding window to determine an intra prediction mode associated with the respective group of samples in the sliding window and determine the one or more intra prediction modes of the current block based on the determined intra prediction modes associated with the respective groups of samples in the left template.

15. The method of claim 9, wherein
the one of the left template and the top template is the top template and includes multiple rows of samples;
the filter type is a 2×3 Sobel-based filter in the plurality of filter types;
the 2×3 Sobel-based filter includes that a horizontal filter Mₜₓ that is
$$[ \begin{matrix}- 1 & - 2 & - 1 \\ 1 & 2 & 1\end{matrix} ]$$
and a horizontal filter M_{ty} that is
$$[ \begin{matrix}1 & 0 & - 1 \\ 3 & 0 & - 3\end{matrix} ] ;$$
and
the applying the DIMD mode includes, for each group of samples in a 2×3 sliding window that traverses the top template one column at a time across the multiple rows of samples, applying Mₜₓ and M_{ty} to the respective group of samples in the 2×3 sliding window to determine an intra prediction mode associated with the respective group of samples in the sliding window and determine the one or more intra prediction modes of the current block based on the determined intra prediction modes associated with the respective groups of samples in the top template.

16. A method of processing visual media data, the method comprising:
processing a bitstream of the visual media data according to a format rule, wherein
the bitstream includes a first syntax element indicating that a current block in a current picture is coded with a decoder-side intra mode derivation (DIMD) mode, a template of the current block that includes reconstructed samples in the current picture being adjacent to the current block and including one of a left template to the left of the current block and a top template above the current block; and
the format rule specifies that
a filter type is determined from a plurality of filter types associated with the one of the left template and the top template;
the DIMD mode is applied to the reconstructed samples in the template based on the determined filter type to determine one or more intra prediction modes for the current block; and
the current block is reconstructed according to the one or more intra prediction modes.

17. The method of claim 16, wherein
the one of the left template and the top template is the left template;
the plurality of filter types includes a 3×3 Sobel filter and a 3×2 Sobel-based filter, the 3×2 Sobel-based filter includes a horizontal filter Mₗₓ and a vertical filter M_{ly}, a middle row in Mₗₓ is [0, 0], a sum of each column in Mₗₓ is 0, and a sum of each row in M_{ly} is 0;
the bitstream includes a second syntax element indicating which one of the 3×3 Sobel filter and the 3×2 Sobel-based filter is applied to the left template; and
the format rule specifies that the filter type is determined as one of the 3×3 Sobel filter and the 3×2 Sobel-based filter based on the second syntax element.

18. The method of claim 16, wherein
the one of the left template and the top template is the top template;
the plurality of filter types includes a 3×3 Sobel filter and a 2×3 Sobel-based filter, the 2×3 Sobel-based filter includes a horizontal filter Mₜₓ and a vertical filter M_{ty}, a middle column in M_{ty} is
$$[ \begin{matrix}0 \\ 0\end{matrix} ] ,$$
a sum of each row in M_{ty} is 0, and a sum of each column in Mₜₓ is 0;
the bitstream includes a third syntax element indicating which one of the 3×3 Sobel filter and the 2×3 Sobel-based filter is applied to the top template; and
the format rule specifies that the filter type is determined as one of the 3×3 Sobel filter and the 2×3 Sobel-based filter based on the third syntax element.

19. The method of claim 16, wherein
the one of the left template and the top template is the left template and includes multiple columns of reconstructed samples;
the filter type is a 3×2 Sobel-based filter in the plurality of filter types;
the 3×2 Sobel-based filter includes a horizontal filter Mux that is
$$[ \begin{matrix}- 1 & - 3 \\ 0 & 0 \\ 1 & 3\end{matrix} ]$$
and a vertical filter M_{ly} that is
$$[ \begin{matrix}1 & - 1 \\ 2 & - 2 \\ 1 & - 1\end{matrix} ] ;$$
and
the format rule specifies that, for each group of reconstructed samples in a 3×2 sliding window that traverses the left template one row at a time across the multiple columns of samples, Mₜₓ and M_{ty} are applied to the respective group of reconstructed samples in the 3×2 sliding window to determine an intra prediction mode associated with the respective group of reconstructed samples in the sliding window and the one or more intra prediction modes of the current block are determined based on the determined intra prediction modes associated with the respective groups of reconstructed samples in the left template.

20. The method of claim 16, wherein
the one of the left template and the top template is the top template and includes multiple rows of reconstructed samples;
the filter type is a 2×3 Sobel-based filter in the plurality of filter types;
the 2×3 Sobel-based filter includes that a horizontal filter Mₜₓ that is
$$[ \begin{matrix}- 1 & - 2 & - 1 \\ 1 & 2 & 1\end{matrix} ]$$
and a horizontal filter M_{ty} that is
$$[ \begin{matrix}1 & 0 & - 1 \\ 3 & 0 & - 3\end{matrix} ] ;$$
and
the format rule specifies that, for each group of reconstructed samples in a 2×3 sliding window that traverses the top template one column at a time across the multiple rows of samples, Mₜₓ and M_{ty} are applied to the respective group of reconstructed samples in the 2×3 sliding window to determine an intra prediction mode associated with the respective group of reconstructed samples in the sliding window and the one or more intra prediction modes of the current block are determined based on the determined intra prediction modes associated with the respective groups of reconstructed samples in the top template.
